(19) United States
(12) Patent Application Publication
(10) Pub. No.: US 2005/0048197 A1
(43) Pub. Date: Mar. 3, 2005

(54) Process for manufacture of radiation image storage panel

(75) Inventors: Yasuo Iwabuchi, Kanagawa (JP); Hiroshi Matsumoto, Kanagawa (JP)

Correspondence Address: SUGHRUE, MION, ZINN, MACPEAK & SEAS, 2100 Pennsylvania Avenue, N. W., Washington, DC, 20037-3202, US

(73) Assignee: FUJI PHOTO FILM CO., LTD.

(21) Appl. No.: 10/927,032

(22) Filed: Aug. 27, 2004

(30) Foreign Application Priority Data
Aug. 27, 2003 (JP) 2003-303467

(51) Int. Cl. B05D 5/06

(52) U.S. Cl. 427/65

(57) ABSTRACT

A radiation image storage panel is manufactured by the steps of heating and vaporizing an evaporation source comprising a phosphor or its starting materials and depositing the vaporized phosphor or materials on a substrate to form a phosphor layer in an evaporation-deposition apparatus, in which the steps are carried out at a pressure of 0.05 to 10 Pa and under the following condition:
0.3≦(T−S)/MFP≦300 in which MFP stands for a mean free path (unit:meter) of the vaporized phosphor or materials, and T−S stands for a space (unit:meter) between the evaporation source and the substrate.

### FIELD OF THE INVENTION

The present invention relates to a process for manufacturing a radiation image storage panel employable in a radiation image recording and reproducing method utilizing an energy-storable phosphor.

### BACKGROUND OF THE INVENTION

When an energy-storable phosphor (e.g., stimulable phosphor, which gives off stimulated emission) is exposed to radiation such as X-rays, it absorbs and stores a portion of the radiation energy. The phosphor then emits stimulated emission according to the level of the stored energy when exposed to electromagnetic wave such as visible or infrared light (i.e., stimulating light). Recently, the radiation image recording and reproducing method utilizing the energy-storable phosphor has been widely employed in practice. In this method, a radiation image storage panel, which is a sheet comprising the energy-storable phosphor, is used. The method comprises the steps of: exposing the storage panel to radiation having passed through an object or having radiated from an object, so that radiation image information of the object is temporarily recorded in the storage panel; sequentially scanning the storage panel with a stimulating light such as a laser beam to emit a stimulated light; and photoelectrically detecting the emitted light to obtain electric image signals. The storage panel thus processed is then subjected to a step for erasing radiation energy remaining therein, and then kept for the use in the next recording and reproducing procedure. Thus, the radiation image storage panel can be repeatedly used.

The radiation image storage panel (often referred to as energy-storable phosphor sheet) has a basic structure comprising a support and an energy-storable phosphor layer provided thereon. However, if the phosphor layer is self-supporting, the support may be omitted. Further, a protective layer is generally provided on a free surface (surface not facing the support) of the phosphor layer to keep the phosphor layer from chemical deterioration or physical damage.

Various kinds of phosphor layer are known and used. For example, a phosphor layer comprising a binder and an energy-storable phosphor dispersed therein is generally used, and a phosphor layer comprising agglomerate of an energy-storable phosphor without binder is also known. The latter layer can be formed by a gas phase-accumulation method or by a firing method. Further, still also known is a phosphor layer comprising energy-storable phosphor agglomerate impregnated with a polymer material.

Japanese Patent Provisional Publication 2001-255610 discloses a variation of the radiation image recording and reproducing method. While an energy-storable phosphor of the storage panel used in the well known method plays both roles of radiation-absorbing function and energy-storable function, those two functions are separated in the disclosed method. In the method, a radiation image storage panel comprising an energy-storable phosphor (which stores radiation energy) is used in combination with a phosphor screen comprising another phosphor which absorbs radiation and emits ultraviolet or visible light. The disclosed method comprises the steps of causing the radiation-absorbing phosphor of the screen (and of the storage panel) to absorb and convert radiation having passed through an object or having radiated from an object into ultraviolet or visible light; causing the energy-storable phosphor of the storage panel to store the energy of the converted light as radiation image information; sequentially exciting the energy-storable phosphor with a stimulating light to emit stimulated light; and photoelectrically detecting the emitted light to obtain electric signals giving a visible radiation image .

The radiation image recording and reproducing method (or radiation image forming method) has various advantages as described above. Nevertheless, it is still desired that the radiation image storage panel used in the method have as high sensitivity and, at the same time, give a reproduced radiation image of high quality (in regard to sharpness and graininess).

In order to improve the sensitivity and the image quality, it is proposed that the phosphor layer of the storage panel be prepared by a gas phase-accumulation method such as vacuum vapor deposition or sputtering. The process of vacuum vapor deposition, for example, comprises the steps of: heating to vaporize an evaporation source comprising a phosphor or its starting materials by means of a resistance heater or an electron beam, and depositing and accumulating the vapor on a substrate such as a metal sheet to form a layer of the phosphor in the form of columnar crystals.

The phosphor layer formed by the gas phase-accumulation method contains no binder and consists essentially of the phosphor only, and there are gaps among the columnar crystals of the phosphor. Because of the gaps, the stimulating light can stimulate the phosphor efficiently and the emitted light can be collected efficiently, too. Accordingly, a radiation image storage panel having that phosphor layer has high sensitivity. At the same time, since the gaps prevent the stimulating light from diffusing parallel to the layer, the storage panel can give a reproduced image of high sharpness.

U.S. Patent Publication No. 2001/0010831A1 discloses a deposition process for preparation of the phosphor layer. In the disclosed process, the deposition is controlled so that the formed phosphor layer may have a lower density than the phosphor itself in a solid state. The phosphor layer formed on the substrate consists of needle-like crystals. The publication also discloses that, in the deposition, an inert gas such as Ar gas at a temperature of 0 to 100° C. is introduced and evacuated so that the inner pressure of the apparatus may be 10 Pa or less.

Japanese Patent Provisional Publication 2001-249198 discloses a binderless storage phosphor screen comprising an alkali metal storage phosphor. The disclosed screen gives an X-ray diffraction spectrum in which (100) and (110) diffraction lines have intensities I₁₀₀ and I₁₁₀, respectively, satisfying the condition of I₁₀₀/I₁₁₀≧1. According to the publication, the screen can be prepared by the deposition process similar to the above. The deposition process described in examples of the publication was carried out under the condition that the distance between the evaporation source and the substrate was set at 10 cm.

### SUMMARY OF THE INVENTION

It is an object of the present invention to provide a process for manufacture of a radiation image storage panel having a phosphor layer excellent in columnar crystallinity.

It is another object of the invention to provide a process for preparation of a radiation image storage panel giving an image of high quality.

The applicant has studied the deposition process for preparation of a phosphor layer of radiation image storage panel, and finally found that there is a specific relation between the mean free path of the vaporized material(s) and the space between the evaporation source and the substrate when the process is performed under a medium vacuum (at a pressure of approx. 0.05 to 10 Pa) by means of, for example, a resistance heater. Thus, it has been discovered that, if the deposition is performed under the condition that the ratio between the mean free path and the space would be in a specific range, a phosphor layer consisting essentially of well-shaped columnar crystals can be obtained.

The present invention resides in a process of manufacture of a radiation image storage panel, comprising the steps of heating and vaporizing an evaporation source comprising a phosphor or starting materials thereof and depositing the vaporized phosphor or materials on a substrate to form a phosphor layer in an evaporation-deposition apparatus, wherein the steps are performed at a pressure of 0.05 to 10 Pa and under the condition satisfying the following formula:
0.3≦(T−S)/MFP≦300
in which MFP stands for a mean free path of the vaporized phosphor or materials in a meter unit, and T−S stands for a space between the evaporation source and the substrate in a meter unit.

The process of the invention, in which the medium-vacuum deposition process is carried out under the condition of 0.3≦(T−S)/MFP≦300, gives a phosphor layer comprising the phosphor in the form of good (well-shaped) columnar crystals and gaps among them. The obtained phosphor layer is highly optical-anisotropic to the stimulating light and the emission, namely, the phosphor layer efficiently transmits it in the thickness direction while efficiently scatters it parallel to the layer plane. Accordingly, the radiation image storage panel manufacture by the invention gives a reproduced radiation image of high sharpness.

### BRIEF DESCRIPTION OF DRAWINGS

FIG. 1 is a sectional view schematically illustrating an example of the evaporation-deposition apparatus used in the invention.

FIG. 2 is a sectional electron-micrograph of the phosphor layer.

FIG. 3 is another sectional electron-micrograph of the phosphor layer.

FIG. 4 is still another sectional electron-micrograph of the phosphor layer.

FIG. 5 is a graph indicating the relationship between the value of (T−S)/MFP and the columnar crystallinity.

### DETAILED DESCRIPTION OF THE INVENTION

In the process of the present invention, atmospheric gas in the apparatus is preferably an inert gas, more preferably As gas. The inert gas pressure in the apparatus is preferably kept in the range of 0.1 to 4 Pa during the step of evaporation-deposition.

The phosphor preferably is an energy-storable phosphor, more preferably a stimulable alkali metal halide phosphor represented by the following formula (I). In the formula (I), M^{I}, X, A and z are preferably Cs, Br, Eu and a number satisfying the condition of 1×10^{31 4}≦z≦0.1, respectively.
M^{I}X·aM^{II}X′₂·bM^{III}X″₃:zA (I)
in which M^{I} is at least one alkali metal selected from the group consisting of Li, Na, K, Rb and Cs; M^{II}, is at least one alkaline earth metal or divalent metal selected from the group consisting of Be, Mg, Ca, Sr, Ba, Ni, Cu, Zn and Cd; M^{III}, is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦b<0.5 and 0<z<1.0, respectively.

In the invention, the mean free path (MFP) of the phosphor or materials (vaporized molecules) vaporized by heating the evaporation source (i.e., MFP of vaporized phosphor or materials) can be calculated according to the following formula (2):
MFP=kT(μmₐ)^{1/2}/(πP_{b}d_{ab}²) (2)
In the formula (2), k is the Boltzmann constant, T is the temperature (K) of the vaporized molecules, mₐ, is the mass of the vaporized molecules, μ is the reduced mass in terms of mₐm_{b}/(mₐ+mₐ) in which m_{b} is the mass of the atmospheric gas molecule, P_{b} is the pressure of the atmospheric gas, and d_{ab} is an average of the diameters of the vaporized molecule and the atmospheric gas molecule.

The substance vaporized by heating the evaporation source containing a phosphor or its starting materials (i.e., vaporized substance) generally is the phosphor itself or its starting materials such as a phosphor matrix compound, an activator compound and/or additives. However, the activator and the additives are generally negligible in amount as compared with the phosphor matrix, and the columnar crystals are mainly composed of the phosphor matrix. Accordingly, in the estimation of the above-mentioned mean free path (MFP), the vaporized substance can be regarded as the matrix compound.

During the steps of evaporation and deposition, atmospheric gas in the apparatus preferably is an inert gas such as Ar gas, Ne gas, and N₂ gas. Particularly preferred is As gas. The pressure of the atmospheric gas (Pb) preferably is in the range of 0.05 to 10 Pa, more preferably in the range of 0.1 to 4 Pa.

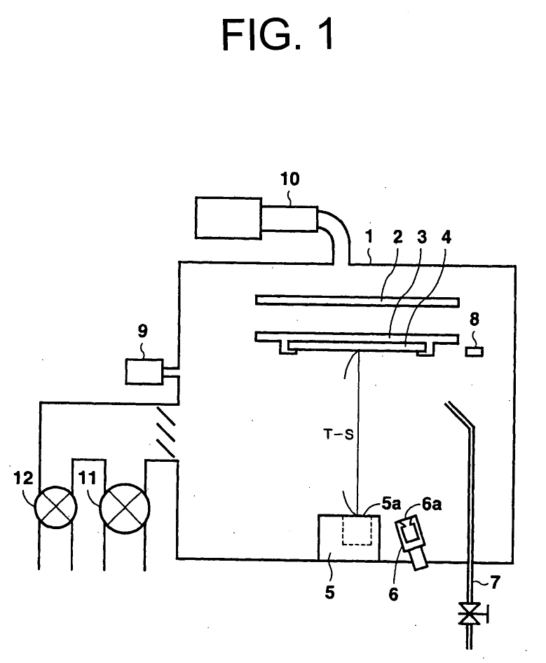

FIG. 1 is a sectional view schematically illustrating an example of the evaporation-deposition apparatus used in the invention. As shown in FIG. 1, the space (T−S) between the evaporation source and the substrate is measured perpendicularly to the substrate. In FIG. 1, the resistance-heating unit 5 charged with the evaporation source 5a is placed at a space of by T−S from the substrate 4, and the space of T−S is measured perpendicularly to the substrate 4.

In the invention, the steps of evaporation and deposition are performed under the condition satisfying the following formula (1) [preferably, satisfying the formula (1a)].
0.3≦(T−S)/MFP≦300 (1)
3≦(T−S)/MFP≦50 (1a)
In the formulas, MFP stands for the mean free path of the vaporized.substance (unit:meter), and T−S stands for the space (unit:meter) between the evaporation source and the substrate.

The steps of evaporation and deposition are carried out under a medium vacuum (at a pressure of 0.05 to 10 Pa) in the manner satisfying the above formula (I). Under the condition, the vaporized substance particles come into collision with each other or with the atmospheric gas molecules to be scattered before the time when they reach onto the substrate. Consequently, the phosphor is deposited and accumulated on the substrate according to the diffusion controlled growth, so that the columnar crystal structure comprising many separated columnar crystals and gaps among them is formed.

In the following description, the process for preparation of the radiation image storage panel of the invention is explained in detail, by way of example, in the case where the phosphor is an energy-storable phosphor and where a resistance-heating process is adopted in the step of evaporation.

The substrate on which the vapor is deposited is that generally used as a support of the radiation image storage panel, and hence can be optionally selected from known materials conventionally used as a support of a radiation image storage panel. The substrate preferably is a sheet of quartz glass, sapphire glass; metal such as aluminum, iron, tin or chromium; or heat-resistant resin such as aramide. Particularly preferred is an aluminum plate. For improving the sensitivity or the image quality (e.g., sharpness and graininess), a conventional radiation image storage panel often has a light-reflecting layer containing a light-reflecting material such as titanium dioxide or a light-absorbing layer containing a light-absorbing material such as carbon black. These auxiliary layers can be provided in the radiation image storage panel of the invention. Further, in order to accelerate growth of the columnar crystals, a great number of very small convexes or concaves may be provided on the substrate surface on which the vapor is deposited. If an auxiliary layer such as a subbing layer (e.g., adhesive layer), a light-reflecting layer or a light-absorbing layer is formed on the deposited-side surface of the substrate, the convexes or concaves may be provided on the surface of the auxiliary layer.

The energy-storable phosphor is preferably a stimulable phosphor giving off stimulated emission in the wave-length region of 300 to 500 nm when exposed to a stimulating ray in the wavelength region of 400 to 900 nm.

The phosphor is particularly preferably an alkali metal halide stimulable phosphor represented by the formula (I):
M^{I}X·aM^{II}X′₂·bM^{III}X″₃:zA (I)
in which M^{I} is at least one alkali metal selected from the group consisting of Li, Na, K, Rb and Cs; M_{II} is at least one alkaline earth metal or divalent metal selected from the group consisting of Be, Mg, Ca, Sr, Ba, Ni, Cu, Zn and Cd; M^{III}is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦b<0.5 and 0<z<1.0, respectively.

In the formula (I), z preferably is a number satisfying the condition of 1×10⁻⁴≦z≦0.1; M^{I} preferably comprises at least Cs; X preferably comprises at least Br; and A is preferably Eu or Bi, more preferably Eu. The phosphor represented by the formula (I) may further comprise metal oxides such as aluminum oxide, silicon dioxide and zirconium oxide as additives in an amount of 0.5 mol or less based on one mol of M^{I}X.

As the phosphor, it is also preferred to use a rare earth activated alkaline earth metal fluoride halide stimulable phosphor represented by the following formula (II):
M^{II}FX:aLn (II)
in which M^{II} is at least one alkaline earth metal selected from the group consisting of Ba, Sr and Ca; Ln is at least one rare earth element selected from the group consisting of Ce, Pr, Sm, Eu, Tb, Dy, Ho, Nd, Er, Tm and Yb; X is at least one halogen selected from the group consisting of Cl, Br and I; and z is a number satisfying the condition of 0<z≦0.2.

In the formula (II), M^{II} preferably comprises Ba more than half of the total amount of M^{II} and Ln is preferably Eu or Ce. The M^{II}FX in the formula (II) represents a matrix crystal structure of BaFX type, and it by no means indicates stoichiometrical composition of the phosphor. Accordingly, the molar ratio of F:X is not always 1:1. It is generally preferred that the BaFX type crystal have many F⁺(X⁻) centers corresponding to vacant lattice points of X⁺ ions since they increase the efficiency of stimulated emission in the wavelength region of 600 to 700 nm. In that case, F is often slightly in excess of X.

Although omitted from the formula (II), one or more additives such as bA, wN^{I}, xN^{II} and yN^{III} may be incorporated into the phosphor of the formula (II). A is a metal oxide such as Al₂O₃, SiO₂ or ZrO₂. In order to prevent M^{II}particles from sintering, the metal oxide preferably has low reactivity with M^{II}FX and the primary particles of the oxide are preferably super-fine particles of 0.1 μm or less diameter. N^{I}, is a compound of at least one alkali metal selected from the group consisting of Li, Na, K, Rb and Cs; N^{II}, is a compound of alkaline earth metal(s) Mg and/or Be; and N^{III} is a compound of at least one trivalent metal selected from the group consisting of Al, Ga, In, Tl, Sc, Y, La, Gd and Lu. The metal compounds preferably are halides, but are not restricted to them.

In the above, b, w, x and y represent amounts of the additives incorporated into the starting materials, provided that the amount of M^{II}FX is assumed to be 1 mol. They are numbers satisfying the conditions of 0≦b≦0.5, 0≦w≦2, 0≦x≦0.3 and 0≦y≦0.3, respectively. These numbers by no means always represent the contents in the resultant phosphor because some of the additives decrease during the steps of firing and washing performed thereafter. Some additives remain in the resultant phosphor as they are added to the materials, but the others react with M^{II}FX or are involved in the matrix.

In addition, the phosphor of the formula (II) may further comprise Zn and Cd compounds; metal oxides such as TiO₂, BeO, MgO, CaO, SrO, BaO, ZnO, Y₂O₃, La₂O₃, In₂O₃, GeO₂, SnO₂, Nb₂O₅, Ta₂O₅ and ThO₂; Zr and Sc compounds; B compounds; As and Si compounds; tetrafluoro-borate compounds; hexafluoro compounds such as monovalent or divalent salts of hexa-fluorosilicic acid, hexafluoro-titanic acid and hexa-fluorozirconic acid; or compounds of transition metals such as V, Cr, Mn, Fe, Co and Ni. The phosphor employable in the invention is not restricted to the phosphors mentioned above, and any phosphor that can be essentially regarded as rare earth activated alkaline earth metal fluoride halide stimulable phosphor can be used.

The phosphor in the invention is not restricted to an energy-storable phosphor. It may be a phosphor absorbing radiation such as X-rays and spontaneously giving off (spontaneous) emission in the ultraviolet or visible region. Examples of these phosphors include phosphors of LnTaO₄: (Nb, Gd) type, Ln₂SiO₅:Ce type and LnOX:Tm type (Ln is a rare earth element); CsX (X is a halogen); Gd₂O₂S:Tb; Gd₂O₂S:Pr, Ce; ZnWO₄; LuAlO₃:Ce; Gd₃Ga₅O₁₂:Cr, Ce; and HfO₂.

In the case where the vapor-deposited phosphor layer is formed by multi-vapor deposition (co-deposition), at least two evaporation sources are used. One of the sources contains a matrix material of the energy-storable phosphor, and the other contains an activator material. The multi-vapor deposition is preferred because the vaporization rate of each source can be independently controlled to incorporate the activator homogeneously in the matrix even if the materials have very different melting points or vapor pressures. According to the composition of the desired phosphor, each evaporation source may consist of the matrix material or the activator material only or otherwise may be a mixture thereof with additives. Three or more sources may be used. For example, in addition to the above-mentioned sources, an evaporation source containing additives may be used.

The matrix material of the phosphor may be either the matrix compound itself or a mixture of two or more substances that react with each other to produce the matrix compound. The activator material generally is a compound containing an activating element, for example, a halide or oxide of the activating element.

If the activator is Eu, the Eu-containing compound of the activator material preferably contains Eu²⁺ in a content of 70% or more by molar ratio because the aimed stimulated emission (even if spontaneous emission) is emitted from the phosphor activated by Eu²⁺ although the Eu-containing compound generally contains both Eu²⁺ and Eu³⁺. The Eu-containing compound is preferably represented by EuXₘ (X: halogen) in which m is a number preferably satisfying the condition of 2.0≦m≦2.3. Ideally the value of m should be 2.0, but oxygen is liable to emigrate into the compound. The compound is, therefore, practically stable when m is approximately 2.2.

The evaporation source preferably has a water content of not more than 0.5 wt. %. For preventing the source from bumping, it is particularly important to control the water content in the above low range if the material of matrix or activator is a hygroscopic substance such as EuBr or CsBr. The materials are preferably dried by heating at 100 to 300° C. under reduced pressure. Otherwise, the materials may be heated under dry atmosphere such as nitrogen gas atmosphere to melt at a temperature above the melting point for several minutes to several hours.

The evaporation source, particularly the source containing the matrix material, may contain impurities of alkali metal (alkali metals other than ones constituting the phosphor) in a content of 10 ppm or less and impurities of alkaline earth metal (alkaline earth metals other than ones constituting the phosphor) in a content of 5 ppm or less (by weight). That is particularly preferred if the phosphor is an alkali metal halide stimulable phosphor represented by the formula (I). Such preferred evaporation source can be prepared from materials containing little impurities.

In the present invention, the phosphor-deposited layer can be formed, for example, in the evaporation-deposition apparatus shown in FIG. 1. The apparatus is equipped with resistance-heating units.

FIG. 1 is a sectional view schematically illustrating an example of the evaporation-deposition apparatus used in the invention. The apparatus shown in FIG. 1 comprises a chamber 1, a substrate heater 2, a substrate holder 3, resistance-heating units 5 and 6, an intake pipe 7, a deposition rate monitor 8, a vacuum gauge 9, a gas analyzer 10, a main exhaust valve 11, and an auxiliary exhaust valve 12.

In the apparatus shown in FIG. 1, the two or more evaporation sources 5a, 6a are placed at predetermined positions on the resistance-heating units 5 and 6. The substrate 4 is mounted on the substrate holder 3. The chamber 1 is then evacuated through the main exhaust valve 11 and the auxiliary exhaust valve 12, to make the inner pressure in the range of 0.05 to 10 Pa, preferably 0.1 to 4 Pa (medium vacuum). Preferably after the chamber 1 is further evacuated to make the inner pressure in the range of 1×10⁻⁵ to 1×10⁻² Pa (high vacuum), an inert gas such as Ar, Ne or N₂ gas is introduced through the intake pipe 7 so that the inner pressure would be in the range of 0.05 to 10 Pa, preferably 0.1 to 4 Pa. In this way, partial pressures of water and oxygen can be reduced. The degree of vacuum in the chamber 1 is monitored with the vacuum gauge 9, and the partial pressures of gases are monitored by means of the gas analyzer 10. The chamber 1 can be evacuated by means of an optional combination of, for example, a rotary pump, a turbo molecular pump, a cryo pump, a diffusion pump and a mechanical buster.

The space (T−S) between the substrate 4 and each of the evaporation sources 5a, 6a is determined so that the aforementioned formula (1) can be satisfied. How long the space (T−S) is set depends on various conditions such as the size of substrate, but generally is in the range of 10 to 1,000 mm. The distance between the evaporation sources 5a and 6a generally is in the range of 10 to 1,000 mm.

For heating the evaporation sources 5a and 6a, electric currents are then supplied to the heating units 5, 6. The sources of matrix and activator materials are thus heated, vaporized, and reacted with each other to form the phosphor, which is deposited on the substrate 4. In this step, the substrate 4 may be heated or cooled from the back side. The temperature of the substrate generally is in the range of 20 to 350° C., preferably in the range of 100 to 300° C. The deposition rate, which means how fast the formed phosphor is deposited and accumulated on the substrate, can be controlled by adjusting the electric currents supplied to the heaters. The deposition rate of each vaporized phosphor component can be detected with the monitor 8 at any time during the deposition. The deposition rate is generally in the range of 0.1 to 1,000 μm/min., preferably in the range of 1 to 100 μm/min.

The heating with resistance-heating units may be repeated twice or more to form two or more phosphor layers. After the deposition procedure is complete, the deposited layer may be subjected to heating treatment (annealing treatment), which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas.

Before preparing the above deposited film (layer) of stimulable phosphor, another deposited film (layer) consisting of the phosphor matrix alone may be beforehand formed. The layer of the phosphor matrix alone generally comprises agglomerate of columnar or spherical crystals, and the phosphor layer formed thereon is well crystallized in the form of columnar shape. The matrix alone-deposited layer also serves as a light-reflecting layer, and increase the amount of emission given off from the surface of the phosphor layer. In addition, if the matrix layer has a relative density in the range of 80 to 98%, it further serves as a stress-relaxing layer to enhance the adhesion between the support and the phosphor layer. In the thus-formed layers, the additives such as the activator contained in the phosphor-deposited layer are often diffused into the matrix alone-deposited layer while they are heated during the deposition and/or during the heating treatment performed after the deposition, and consequently the interface between the layers is not always clear.

In the case where the phosphor layer is produced by mono-vapor deposition, only one evaporation source containing the above stimulable phosphor or a mixture of materials thereof is heated with a single resistance-heating unit. The evaporation source is beforehand prepared so that it may contain the activator in a desired amount. Otherwise, in consideration of the gap of vapor pressure between the matrix components and the activator, the deposition procedure may be carried out while the matrix components are being supplied to the evaporation source.

Thus produced phosphor layer consists of a stimulable phosphor in the form of columnar crystals grown almost in the thickness direction. The phosphor layer contains no binder and consists of the stimulable phosphor only, and there are gaps among the columnar crystals. The thickness of the phosphor layer depends on, for example, aimed characters of the panel, conditions and process of the deposition, but is generally in the range of 50 μm to 1 mm, preferably in the range of 200 to 700 μm.

The apparatus employable in the invention is not restricted to that shown in FIG. 1, and the gas phase-accumulation method usable in the invention is not restricted to the above-described resistance heating process, and various other known processes can be used as long as the deposition is carried out under a medium vacuum.

It is not necessary that the substrate is a support of the radiation image storage panel. For example, after formed on the substrate, the deposited phosphor film is peeled from the substrate and then laminated on a support with an adhesive to prepare the phosphor layer. Otherwise, the support (substrate) may be omitted.

It is preferred to provide a protective layer on the surface of the phosphor layer, so as to ensure good handling of the storage panel in transportation and to avoid deterioration. The protective layer preferably is transparent so as not to prevent the stimulating light from coming in or not to prevent the emission from coming out. Further, for protecting the storage panel from chemical deterioration and physical damage, the protective layer preferably is chemically stable, physically strong, and of high moisture proof.

The protective layer can be provided by coating the stimulable phosphor layer with a solution in which an organic polymer such as cellulose derivatives, polymethyl methacrylate or fluororesins soluble in an organic solvent is dissolved in a solvent, by placing a beforehand prepared sheet for the protective layer (e.g., a film of organic polymer such as polyethylene terephthalate, a transparent glass plate) on the phosphor layer with an adhesive, or by depositing vapor of inorganic compounds on the phosphor layer. Various additives may be dispersed in the protective layer. Examples of the additives include light-scattering fine particles (e.g., particles of magnesium oxide, zinc oxide, titanium dioxide and alumina), a slipping agent (e.g., powders of perfluoroolefin resin and silicone resin) and a cross-linking agent (e.g., polyisocyanate). The thickness of the protective layer generally is in the range of about 0.1 to 20 μm if the layer is made of polymer material or in the range of about 100 to 1,000 μm if the protective layer is made of inorganic material such as glass.

For enhancing the resistance to stain, a fluororesin layer may be further provided on the protective layer. The fluororesin layer can be form by coating the surface of the protective layer with a solution in which a fluororesin is dissolved (or dispersed) in an organic solvent, and drying the applied solution. The fluororesin may be used singly, but a mixture of the fluororesin and a film-forming resin is generally employed. In the mixture, an oligomer having a polysiloxane structure or a perfluoroalkyl group can be further added. In the fluororesin layer, fine particle filler may be incorporated to reduce blotches caused by interference and to improve the quality of the resultant image. The thickness of the fluororesin layer generally is in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

Thus, a radiation image storage panel of the invention can be produced. The radiation image storage panel of the invention may be in known various structures. For example, in order to improve the sharpness of the resultant image, at least one of the films (layers) may be colored with a colorant which does not absorb the stimulated emission but the stimulating ray.

### EXAMPLE 1

(1) Evaporation Source

As the evaporation sources, powdery cesium bromide (CsBr, purity: 4N or more) and powdery europium bromide (EuBrₘ, m is approx. 2.2, purity: 3N or more) were prepared. Each of them was analyzed according to ICP-MS method (Inductively Coupled Plasma Mass Spectrometry), to find contents of impurities. It was found that the CsBr powder contained each of the alkali metals (Li, Na, K, Rb) other than Cs in an amount of 10 ppm or less and other elements such as alkaline earth metals (Mg, Ca, Sr, Ba) in amounts of 2 ppm or less. The EuBrₘ powder contained each of the rare earth elements other than Eu in an amount of 20 ppm or less and other elements in amounts of 10 ppm or less. The powders are very hygroscopic, and hence were stored in a desiccator keeping a dry condition whose dew point was −20° C. or below. Immediately before used, they were taken out of the desiccator.

(2) Preparation of Phosphor Layer

A synthetic quartz substrate as a support was washed successively with an aqueous alkaline solution, purified water and IPA (isopropyl alcohol). Thus treated substrate 4 was mounted to the substrate holder 3 in the evaporation-deposition apparatus shown in FIG. 1. The CsBr and EuBrₘ evaporation sources 5a, 6a were individually placed in crucibles of the resistance-heating units 5 and 6, respectively. The space (T−S) between the substrate 4 and each of the sources 5a, 6a was set at 0.12 m. The chamber 1 of the apparatus was then evacuated through the main exhaust valve 11 and the auxiliary exhaust valve 12, to make the inner pressure 1×10⁻³ Pa by means a combination of a rotary pump, a mechanical booster and a turbo molecular pump, and successively Ar gas (purity: 5N) was introduced through the intake pipe 7 to set the inner pressure at 0.1 Pa (Ar gas pressure). The substrate 4 was then heated to 100° C. by means of the substrate heater 2. Each evaporation source 5a, 6a was also heated, so that CsBr:Eu stimulable phosphor was accumulated on the surface of the substrate 4 at a deposition rate of 5 μm/min. During the deposition, the electric currents supplied to the heating units 5, 6 were controlled so that the molar ratio of Eu/Cs in the stimulable phosphor would be 0.003/1. Each source was first covered with a shutter (not shown), which was opened later to start the evaporation of CsBr or EuBr. After the evaporation-deposition was complete, the inner pressure of the chamber 1 was returned to atmospheric pressure and then the substrate 4 was taken out of the apparatus. On the substrate, a deposited layer (thickness: 500 μm, area: 10 cm×10 cm) consisting of columnar phosphor crystals aligned densely and almost perpendicularly was formed. Thus, a radiation image storage panel of the invention comprising the support and the phosphor layer was produced by multi-vapor deposition.

### EXAMPLES 2 to 4

The procedure of Example 1 was repeated except that the amount of introduced Ar gas was changed so that the pressure of Ar gas in the apparatus would be set at each value shown in Table 1, to produce various radiation image storage panels according to the invention.

### COMPARISON EXAMPLES 1 and 2

The procedure of Example 1 was repeated except that the amount of introduced Ar gas was changed so that the pressure of Ar gas in the apparatus might be set at each value shown in Table 1, to produce two radiation image storage panels for comparison.

### EXAMPLES 5 to 9

The procedure of Example 1 was repeated except that the Ar gas pressure in the apparatus and the space (T−S) between the substrate and each evaporation source were changed into those shown in Table 1, to produce various radiation image storage panels according to the invention.

### COMPARISON EXAMPLES 3 to 9

The procedure of Example 1 was repeated except that the Ar gas pressure in the apparatus and the space (T−S) between the substrate and each evaporation source were changed into those shown in Table 1, to produce various radiation image storage panels for comparison.

### Evaluation of Radiation Image Storage Panel

First, the mean free path MFP (m) of vaporized molecules (CsBr molecules) in each example or comparison example was calculated according to the following formula (2):
MFP=kT(μmₐ)^{1/2}/(πP_{b}d_{ab}²) (2)

in which the used values are as follows:

| | |
|---|---|
| k | Boltzmann constant |
| T (temperature of vaporized CsBr) | 900K |
| mₐ (mass of CsBr molecule) | 212.8 |
| m_{b} (mass of Ar molecule) | 39.94 |
| μ (reduced mass) | mₐm_{b}/(mₐ + mₐ) |
| P_{b} | pressure of Ar gas |
| d_{ab} (average diameter of CsBr | 1 nm (= 1 × 10⁻⁹ m). |
| and Ar molecules) | |

On the basis of the obtained MFP value, the value of (T−S)/MFP was calculated.

Then, the columnar crystallinity of each produced storage panel was evaluated in the following manner.

The phosphor layer was perpendicularly cut together with the support and covered with a gold thin film (thickness: 300 angstrom) formed by means of ion-sputtering so as to prevent the layer from electrification. The surface and the section of the thus-treated phosphor layer were observed with a scanning electron microscope (JSM-5400, JEOL, Ltd.) to examine the shape of columnar crystals and gaps among them. According to the observation, the produced storage panels were classified into the following five grades.
Grade 1: None of the gaps are continuously formed along the columnar crystals.
Grade 2: Almost half of the gaps are continuously formed along the columnar crystals.
Grade 3: There is no gap among the columnar crystals in some areas, and the crystals have rough surfaces.
Grade 4: Although the gaps are continuously formed along the columnar crystals, the crystals have rough surfaces.
Grade 5: The gaps are continuously formed along the columnar crystals, and the crystals have smooth surfaces.

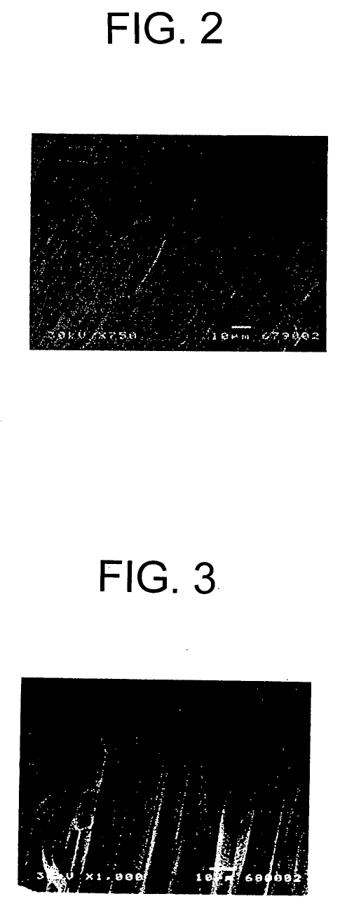

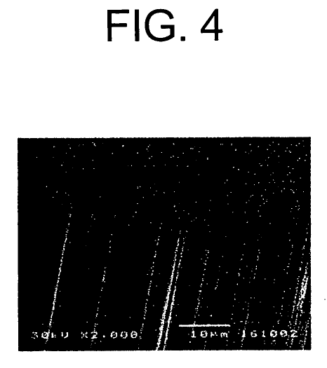

FIGS. 2, 3 and 4 are sectional electron-micrographs of phosphor layers classified into the grades 1, 3 and 5, respectively. Magnifications of the micrographs are 2,000-fold (FIGS. 2 and 3) and 1,500-fold (FIG. 4).

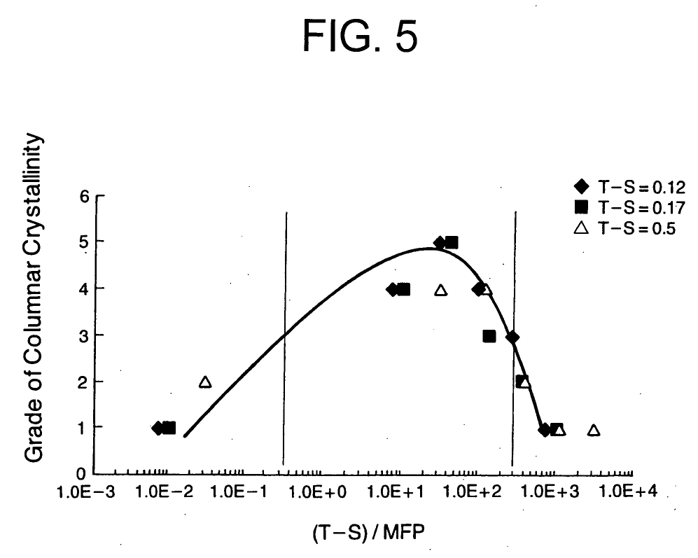

The results are shown in Table 1 and FIG. 5.

FIG. 5 is a graph indicating the relation between the value of (T−S)/MFP and the grade of columnar crystallinity.

TABLE 1

| | Ar gas | | | | Grade of |
|---|---|---|---|---|---|
| | pressure | MFP | T-S | (T-S)/ | columnar |
| Ex. | (Pa) | (m) | (m) | MFP | crystallinity |
| Ex. 1 | 0.1 | 1.6 × 10⁻² | 0.12 | 7.6 | 4 |
| Ex. 2 | 0.4 | 3.9 × 10⁻³ | 0.12 | 3.1 × 10¹ | 5 |
| Ex. 3 | 1.3 | 1.2 × 10⁻³ | 0.12 | 9.9 × 10¹ | 4 |
| Ex. 4 | 3.6 | 4.4 × 10⁻⁴ | 0.12 | 2.7 × 10² | 3 |
| Com. 1 | 0.0001 | 1.6 × 10¹ | 0.12 | 7.6 × 10⁻³ | 1 |
| Com. 2 | 10 | 1.6 × 10⁻⁴ | 0.12 | 7.6 × 10² | 1 |
| Ex. 5 | 0.1 | 1.6 × 10⁻² | 0.17 | 1.1 × 10¹ | 4 |
| Ex. 6 | 0.4 | 3.9 × 10⁻³ | 0.17 | 4.3 × 10¹ | 5 |
| Ex. 7 | 1.3 | 1.2 × 10⁻³ | 0.17 | 1.4 × 10² | 3 |
| Com. 3 | 0.0001 | 1.6 × 10¹ | 0.17 | 1.1 × 10⁻² | 1 |
| Com. 4 | 3.6 | 4.4 × 10⁻⁴ | 0.17 | 3.9 × 10² | 2 |
| Com. 5 | 10 | 1.6 × 10⁻⁴ | 0.17 | 1.1 × 10³ | 1 |
| Ex. 8 | 0.1 | 1.6 × 10⁻² | 0.50 | 3.2 × 10¹ | 4 |
| Ex. 9 | 0.4 | 3.9 × 10⁻³ | 0.50 | 1.3 × 10² | 4 |
| Com. 6 | 0.0001 | 1.6 × 10¹ | 0.50 | 3.2 × 10⁻² | 2 |
| Com. 7 | 1.3 | 1.2 × 10⁻³ | 0.50 | 4.1 × 10² | 2 |
| Com. 8 | 3.6 | 4.4 × 10⁻⁴ | 0.50 | 1.1 × 10³ | 1 |
| Com. 9 | 10 | 1.6 × 10⁻⁴ | 0.50 | 3.2 × 10³ | 1 |

The results shown in Table 1 and FIG. 5 clearly indicate that the radiation image storage panels manufactured according to the invention (Examples 1 to 9), in which the deposition was carried out with the (T−S)/MFP value kept in the range of 0.3 to 300, were excellent in columnar crystallinity, as compared with those for comparison (Comparison Examples 1 to 9), whose phosphor layers were produced by deposition not satisfying the above-mentioned condition.

### EXAMPLE 10

The procedure of Example 1 was repeated except that N₂ gas was introduced in place of Ar gas so that the pressure of N₂ gas would be 0.4 Pa, 1.3 Pa or 10 Pa, to produce various radiation image storage panels according to the invention. Thus produced storage panels were evaluated in the same manner as described above. It was confirmed that, even if N₂ gas was used in place of Ar gas as the atmospheric gas, the obtained results were similar to the above storage panels (whose phosphor layers were formed by deposition in which Ar gas was used as the atmospheric gas).

1. A process of manufacture of a radiation image storage panel, comprising the steps of heating and vaporizing an evaporation source comprising a phosphor or starting materials thereof and depositing the vaporized phosphor or materials on a substrate to form a phosphor layer in an evaporation-deposition apparatus, wherein the steps are performed at a pressure of 0.05 to 10 Pa and under the condition satisfying the following formula:
0.3≦(T−S)/MFP≦300
in which MFP stands for a mean free path of the vaporized phosphor or materials in a meter unit, and T−S stands for a space between the evaporation source and the substrate in a meter unit.

2. The process of claim 1, wherein the steps are performed in an inert gas atmosphere.

3. The process of claim 2, wherein the inert gas is Ar gas.

4. The process of claim 1, wherein the steps are performed at a pressure of 0.1 to 4 Pa.

5. The process of claim 1, wherein the phosphor layer comprises an energy-storable phosphor.

6. The process of claim 5, wherein the energy-storable phosphor is a stimulable alkali metal halide phosphor represented by the following formula:
M^{I}X.aM^{II}X′₂.bM^{III}X″₃:zA
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦b<0.5 and 0<z<1.0, respectively.

7. The process of claim 6, wherein M^{I} is Cs, X is Br, A is Eu, and z is a number satisfying the condition of 1×10⁻⁴≦z≦0.1.
